(19) United States
(12) Patent Application Publication
(10) Pub. No.: US 2026/0021484 A1
(43) Pub. Date: Jan. 22, 2026

(54) FINGER-ACTUATED SYSTEMS AND METHODS FOR ELECTROCHEMICAL MEASUREMENTS OF PROTEIN BIOMARKERS FOR POINT-OF-CARE TESTING

(71) Applicant: William Marsh Rice University, Houston, TX (US)

(72) Inventors: Peter B. LILLEHOJ, Houston, TX (US); Desh D. DIXIT, Houston, TX (US); Benjamin C. UTZINGER, Houston, TX (US)

(73) Assignee: William Marsh Rice University, Houston, TX (US)

(21) Appl. No.: 19/261,924

(22) Filed: Jul. 7, 2025

Related U.S. Application Data
(60) Provisional application No. 63/671,984, filed on Jul. 16, 2024.

(51) Int. Cl. B01L 3/00

(52) U.S. Cl. CPC B01L 3/502715; B01L 3/50273; B01L 2200/0689; B01L 2300/0645; B01L 2300/0867; B01L 2400/0475

(57) ABSTRACT

Embodiments of the present disclosure include apparatus, systems and methods related to sample analysis. Particular embodiments include a microfluidic electrochemical immunosensor that employ a unique finger-actuated mixer for rapid, ultrasensitive measurements of protein biomarkers. This mixer generates swirling microflows in the liquid sample, which accelerates biomolecular transport, enhances antibody-antigen reactions and promotes immunocomplex formation. In specific embodiments, mixing can be implemented during the incubation steps, which accelerates biomolecular transport and promotes immunocomplex formation, leading to enhanced analytical sensitivity and a shortened detection time.

### CROSS-REFERENCE TO RELATED APPLICATIONS

This application claims priority to U.S. Provisional Patent Application Ser. No. 63/671,984 filed Jul. 16, 2024, the entire contents of which are incorporated herein by reference.

### STATEMENT REGARDING FEDERALLY SPONSORED RESEARCH AND DEVELOPMENT

This invention was made with government support under R21CA283852 awarded by the National Institutes of Health. The government has certain rights in the invention.

### BACKGROUND

### A. Field

This disclosure relates to apparatus, systems and methods to analyze a sample with high sensitivity in a point-of-care format utilizing user-actuated mixing that does not require outside power sources.

### B. Related Art

In vitro diagnostic testing plays an important role in various clinical applications, including diagnosing diseases and monitoring therapeutic response [1]. Existing diagnostic tests for high sensitivity detection of protein biomarkers involve long incubation times or require bulky/expensive instrumentation, hindering their use for point-of-care testing.

Currently, the most commonly used technique for sensitive protein detection is enzyme-linked immunosorbent assay (ELISA). While ELISA is considered a clinical gold standard, it involves long (1.5-3 hr) incubation times, requires expensive and specialized equipment (e.g., plate reader) and highly trained personnel [2], all of which limits its use to laboratory settings. To overcome these limitations, researchers have developed portable biosensing platforms capable of rapid and sensitive protein measurements, which can be used for point-of-care testing [3-6]. Of the various sensing modalities, including fluorescence, electrochemical and surface plasmon resonance (SPR), that have been employed for these platforms, electrochemical sensing offers the advantages of high analytical sensitivity, fast turnaround times, ease of use and portability [7-9]. Furthermore, electrochemical sensors can be fabricated on disposable substrates, such as plastic, paper and textile, reducing the cost associated with testing [10-12].

Affinity-based sensors are commonly used for electrochemical sensing of protein

biomarkers [13]. These immunosensors employ biorecognition elements, such as antibodies, antigens or aptamers, that selectively bind to the target protein. While affinity-based sensors are capable of high sensitivity and high specificity measurements, they involve lengthy (approximately 1 hour) incubations, which makes them poorly suited for applications requiring

fast turnaround times, such as rapid diagnostic testing [14]. Various techniques have been demonstrated to accelerate mass transport and enhance antibody-antigen interactions in surface binding immunoassays. Microfluidic flows have been used to confine the sample close to the sensor surface or continuously refresh the sensor with fresh analyte [16].

Alternatively, AC electrothermally-driven flows have been used to accelerate biomolecular transport and promote immunocomplex formation in an electrochemical immunoassay, resulting in enhanced analytical performance [17]. While these methods have been successful in reducing the detection time and improving the analytical sensitivity, they require complicated fluidic systems or specialized equipment (e.g., syringe pump, voltage amplifier, function generator), hindering their use for point-of-care testing.

Accordingly, a need exists to address these issues, as well as others, to analyze a sample with high sensitivity in a point-of-care format that does not require outside power sources

### SUMMARY

Embodiments of the present disclosure include apparatus, systems and methods related to sample analysis. Particular embodiments include a microfluidic electrochemical immunosensor that employs a unique finger-actuated mixer for rapid, ultrasensitive measurements of protein biomarkers. In specific embodiments, mixing was implemented during the incubation steps, which accelerated biomolecular transport and promoted immunocomplex formation, leading to enhanced analytical sensitivity and a shortened detection time.

Electrochemical measurements were performed using a handheld diagnostic device consisting of a smartphone and miniature potentiostat. Proof of principle was demonstrated by using this platform for quantitative measurements of C-X-C motif chemokine ligand 9 (CXCL9), a serological biomarker for autoimmune and inflammatory diseases, which could be detected in human plasma at concentrations as low as 4.7 pg mL⁻¹ in <25 min. The ability to rapidly detect protein biomarkers with high sensitivity in a point-of-care format makes this device a promising tool for diagnostic testing, particularly in resource-limited settings.

Exemplary embodiments of the present disclosure utilize a unique strategy for improving the analytical performance of an affinity-based electrochemical immunosensor via mixing-enhanced incubation using a finger-actuated mixer. In contrast to previously reported biosensing platforms that employ mixing to enhance the sensing performance, exemplary embodiments of the present disclosure do not require additional instrumentation or grid electricity, making it suitable for point-of-care testing in resource-limited settings. Microfluidic biosensing platforms employing finger-powered pumping for liquid transport have previously been reported. [18-21] Liu et al. developed a microfluidic electrochemical sensor employing a finger-actuated micropump, which was used to drive the sample through a serpentine channel for mixing [22]. While these prior reports demonstrate the feasibility of pumping and mixing

liquids inside microchannels via finger actuation, they required complex fabrication processes or were not able to achieve high sensitivity (pg mL⁻¹) detection of protein biomarkers.

Exemplary embodiments of the present disclosure provide an electrochemical immunosensor integrated with a unique finger-actuated mixer on a microfluidic chip. This mixer generates swirling microflows in the liquid sample, which accelerates biomolecular transport, enhances antibody-antigen reactions and promotes immunocomplex formation. The finger-actuated mixing strategy generates micro vortices to enhance the interaction between chemical and biological molecules. In exemplary embodiments, the mixing takes place in an open well, allowing easy accessibility of the analyte, which can either be used in the downstream analysis or integrated with measurement techniques, such as the electrochemical method shown in the attached manuscript. This enhanced mixing strategy can be utilized in the fields where improved interaction between chemical and biological molecules is important for accurate quantitative or qualitative measurements.

Exemplary embodiments include an apparatus for analyzing a sample, where the apparatus comprises: a sample well; a first actuation chamber; a first nozzle; a second actuation chamber; a second nozzle; and a sensor, where the first actuation chamber is in fluid communication with the sample well via the first nozzle, and the second actuation chamber is in fluid communication with sample well via the second nozzle.

In certain embodiments the sample well is configured to allow a user to access the sample well. In particular embodiments the sample well comprises a removable seal. In some embodiments the first nozzle and the second nozzle are directed towards a center region of the sample well. In specific embodiments the first nozzle and the second nozzle are oriented approximately 180 degrees apart. In certain embodiments the first nozzle and the second nozzle are directed towards each other. In particular embodiments at least one of the first nozzle or the second nozzle has a contraction ratio of approximately 1.5 to 2.5. In some embodiments at least one of the first nozzle or the second nozzle has a contraction ratio of approximately 2.0. In specific embodiments both the first nozzle and the second nozzle have a contraction ratio of approximately 2.0.

In certain embodiments the apparatus does not comprise an additional nozzle in addition to the first nozzle and the second nozzle. In particular embodiments the sensor comprises a screen-printed gold electrode. In some embodiments the first actuation chamber and the second actuation comprise a plastic film.

Exemplary embodiments include a method of analyzing a sample, where the method comprises: introducing the sample to a sample well; depressing a first actuation chamber to direct fluid flow through a first nozzle into the sample well; depressing a second actuation chamber to direct fluid flow through a second nozzle into the sample well; and analyzing the sample via a sensor.

Certain embodiments further comprise alternately repeating depressing the first actuation chamber and the second actuation chamber. In particular embodiments the sample well comprises a removable seal; and the method further comprises removing the removable seal prior to introducing the sample to a sample well. In some embodiments the first nozzle and the second nozzle are directed towards a center region of the sample well. In specific embodiments the first nozzle and the second nozzle are oriented approximately 180 degrees apart. In certain embodiments the first nozzle and the second nozzle are directed towards each other. In particular embodiments at least one of the first nozzle or the second nozzle has a contraction ratio of approximately 1.5 to 2.5. In some embodiments at least one of the first nozzle or the second nozzle has a contraction ratio of approximately 2.0. In specific embodiments both the first nozzle and the second nozzle have a contraction ratio of approximately 2.0.

In certain embodiments the apparatus does not comprise an additional nozzle in addition to the first nozzle and the second nozzle. In particular embodiments the sensor comprises a conductive planar electrode. In some embodiments the first actuation chamber and the second actuation comprise a plastic film. In specific embodiments depressing the first actuation chamber and the second actuation comprises depressing the plastic film.

Any embodiment of any of the present methods, composition, kit, and systems may consist of or consist essentially of-rather than comprise/include/contain/have-the described steps and/or features. Thus, in any of the claims, the term “consisting of” or “consisting essentially of” may be substituted for any of the open-ended linking verbs recited above, in order to change the scope of a given claim from what it would otherwise be using the open-ended linking verb.

In the following disclosure, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The terms “about” and “approximately” mean, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 illustrates a smartphone-based diagnostic device for mixing-enhanced electrochemical measurements of protein biomarkers. Panel (A) shows a photograph of the handheld device consisting of a smartphone, Sensit Smart potentiostat and microfluidic immunosensor chip. Panel (B) shows a photograph of one embodiment of a microfluidic immunosensor chip. Inset shows an enlarged view of the nozzle. Scale bar, 1 mm. Panel (C) shows a schematic depicting the operation of the finger-actuated mixer.

FIG. 2 illustrates an exploded view of the embodiment of the microfluidic immunosensor chip of FIG. 1.

FIG. 3 illustrates mesh configurations for the numerical simulations. Mesh configuration for the side view (A) and top view (B) simulations.

FIG. 4 illustrates a schematic illustrations depicting the sensing scheme in the presence of the target protein. Panel (A) shows the sample-dAb-AuNP mixture is dispensed in the sample well, followed by panel (B) showing mixing-enhanced incubation and panel (C) washing. Panel (D) shows SA-HRP solution is dispensed in the sample well, followed by (E) a second round of mixing-enhanced incubation and panel (F) washing. Panel (G) shows TMB peroxidase substrate is dispensed in the sample well, followed by the application of a bias potential between the working and reference electrodes, which results in the generation of an amperometric signal.

FIG. 5 illustrates optimization of the mixer design. Numerical simulation results of the streamlines and the velocity contour in the sample well 0.5 s after actuating the mixer having a (A) tangential design with one inlet and one outlet with constant-width channels, (B) radial design with one inlet and one outlet with constant-width channels, (C) radial design with two inlets and two outlets with constant-width channels, (D) tangential design with one inlet and one outlet with nozzles (contraction ratio=2), (E) radial design with one inlet and one outlet with nozzles (contraction ratio=2), (F) radial design with two inlets and two outlets with nozzles (contraction ratio =2), and (G) radial design with one inlet and one outlet with nozzles (constriction ratio=5).

FIG. 6 illustrates characterization of the finger-actuated mixer for different mixer designs. Sequential still frame images showing the distribution of red polystyrene beads dispensed in a PBS droplet in the sample well of microfluidic chips (without the SPGE sensor) with different mixer designs actuated at approximately 2 Hz.

FIG. 7 illustrates characterization of fluid flow in the sample well upon actuating the mixer. Numerical simulation results of the streamlines and velocity contour at varying time points as observed from the side (A, i) and top (B, i) of the well. Sequential still frame images showing the motion of 10 μm red polystyrene beads in 1×PBS in the sample well of a microfluidic chip (without the SPGE sensor) as observed from the side (A, ii) and top (B, ii) of the well.

FIG. 8 illustrates fluid velocity generated in the channel for different actuation cycles using the radial mixer with a single inlet and outlet. The horizontal dashed line represents the mean velocity from all of the actuation cycles.

FIG. 9 illustrates optimization of the immunosensor. (A) SBRs obtained from human plasma samples spiked with CXCL9 at 0 ng mL⁻¹ or 10 ng mL⁻¹ using varying volumes of dAb-AuNP solution. (B) SBRs obtained from plasma samples spiked with CXCL9 at 0 ng mL⁻¹ or 10 ng mL⁻¹ using varying cAb concentrations. (C) SBRs obtained from plasma samples spiked with CXCL9 at 0 ng mL⁻¹ or 10 ng mL⁻¹ with varying mixing time-to-static incubation time ratios. (D) SBRs obtained from plasma samples spiked with CXCL9 at 0 ng mL⁻¹ or 10 ng mL⁻¹ with varying total mixing and incubation times using a 3:2 mixing time-to-incubation time ratio. Each bar represents the mean±standard deviation (SD) of three independent measurements obtained using new immunosensor chips.

FIG. 10 illustrates performance of the mixing-enhanced immunosensor for quantifying CXCL9 in human plasma. (A) Amperometric currents generated from plasma samples spiked with CXCL9 at 0 ng mL⁻¹ or 1 ng mL⁻¹ and corresponding SBRs with and without mixing-enhanced incubations. Each bar represents the mean±SD of three independent measurements obtained using new immunosensor chips. (B) Chronoamperograms generated from plasma samples spiked with CXCL9 at concentrations from 0 to 10,000 pg mL⁻¹ with mixing-enhanced incubations using the handheld diagnostic device. (C) Calibration plot based on amperometric currents at 120 s obtained from chronoamperograms in panel B. Inset shows amperometric currents for samples containing CXCL9 from 0 to 10 pg mL⁻¹. Each point represents the mean ±SD of three independent measurements obtained using new immunosensor chips.

### DETAILED DESCRIPTION OF EXEMPLARY EMBODIMENTS

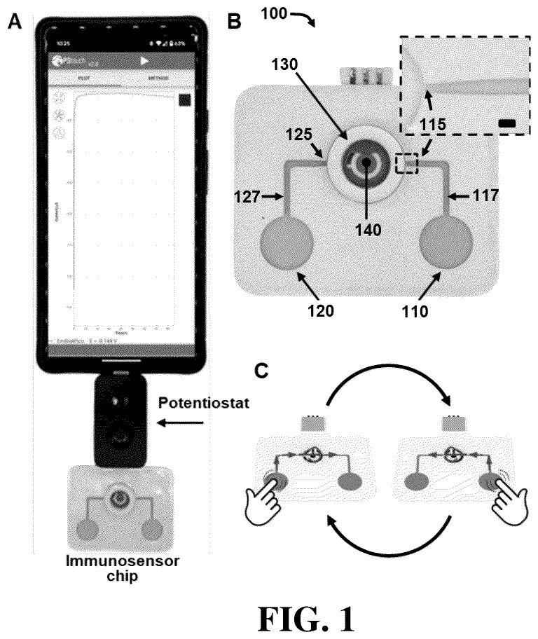

Referring initially to FIG. 1, panel B, an apparatus 100 for analyzing a sample is illustrated. In this embodiment, apparatus 100 comprises a sample well 130, a first actuation chamber 110, a first nozzle 115, a second actuation chamber 120, a second nozzle 125 and a sensor 140. In the embodiment shown, first actuation chamber 110 is in fluid communication with sample well 130 via a first channel 117 and first nozzle 115. Similarly, second actuation chamber 120 is in fluid communication with sample well 130 via a second channel 127 and second nozzle 125. In certain embodiments, sample well 130 may comprise a removable seal (not shown in the figures) to provide a sealed environment for the contents of sample well 130, first and second actuation chambers 110 and 120, first and second channels 117 and 127, and first and second nozzles 115 and 125. A user can remove removable seal and then access the sample well to introduce a sample to sample well 130.

As explained in further detail below, the user can then alternately depress first and second actuation chambers 110 and 120 to direct analysis fluids through nozzles 115 and 125 to mix with the sample and prepare the sample for analysis via sensor 140. As shown in FIG. 1, panel C, alternately repeating depression of first and second actuation chambers 110 and 120 can direct the analysis fluids and sample mixture back and forth between ac

Electrochemical measurements were preformed using a handheld smartphone-based diagnostic device (shown in FIG. 1, panel A), enabling its use in resource-limited settings. The functionality of this platform was evaluated by measuring CXCL9, a serological biomarker for autoimmune and inflammatory diseases, [23-28] in spiked human plasma samples, which could be detected at concentrations as low as 4.7 pg mL⁻¹ in less than 25 minutes, making it a promising diagnostic tool for point-of-care testing.

Experimental testing of one specific embodiment according to the present disclosure was performed, as discussed further below. It is understood that the specific components and features discussed herein are exemplary of one embodiment, but other embodiments according to the present disclosure may comprise different components and features. For example, embodiments of the present disclosure can be adapted to detect other protein biomarkers by changing the capture and detection antibodies. Exemplary embodiments can also be incorporated with other electrochemical and non-electrochemical sensing modalities, such as optical (fluorescence), thermal, magnetic or electrical, to expand its application range.

Furthermore, exemplary embodiments of the present disclosure can be used in a broad range of applications, including the detection of other biomarkers, including proteins, nucleic acids and pathogens (e.g., viruses, bacteria). For example, rapid COVID-19 testing, blood glucose monitoring, hormone level testing, drug metabolism studies, food safety testing, water quality monitoring, cardiac marker detection, allergen detection, veterinary diagnostics, and detection of autoantibodies.

The testing of this embodiment utilized dimethyl sulfoxide (DMSO), phosphate-buffered saline (PBS, pH 7.4), (ethylenedinitrilo)tetraacetic acid (EDTA), bovine serum albumin (BSA), 2-Iminothiolane hydrochloride (Traut's reagent), Tween 20, sucrose, 30 nm gold nanoparticles (AuNPs), 10 μm red polystyrene microbeads, and 3,3′,5,5′-Tetramethylbenzidine (TMB) peroxidase substrate (CAS No. 54827-17-7) purchased from Sigma-Aldrich (St Louis, MO). StabilBlock immunoassay stabilizer was purchased from SurModics, Inc. (Eden Prairie, MN). CXCL9 protein, anti-CXCL9 capture antibody, anti-CXCL9-MIG biotinylated detection antibody, and streptavidin-horseradish peroxidase (SA-HRP) were purchased from R&D Systems (Minneapolis, MN). Screen-printed gold electrode (SPGE) sensors were purchased from MetroOhm AG (Switzerland). Human plasma from healthy donors was purchased from BioIVT. All human samples were de-identified of identifying information.

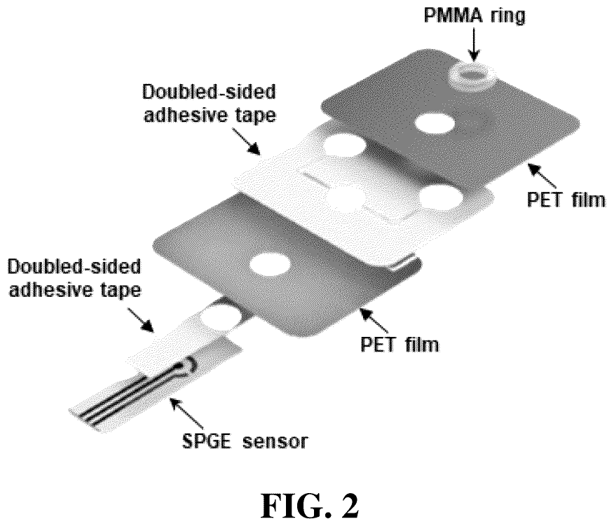

For the experimental testing, a microfluidic chip according to an exemplary embodiment of the present disclosure was designed using AutoCAD software (Autodesk, San Francisco, CA). Microchannels and cutouts for the sample well and actuation chambers were generated in polyethylene terephthalate (PET) film (Optiazure, China) and double-sided adhesive tape (3M, St. Paul, MN) using a CO2 laser cutter (Universal Laser Systems, Scottsdale, AZ). The laser-cut pieces were assembled together and attached to the SPGE sensor using double-sided adhesive tape as shown in FIG. 2. An 8 mm-diameter ring was laser cut from 3 mm-thick polymethyl methacrylate (PMMA) (McMaster-Carr, Elmhurst, IL) and attached to the chip using double-sided adhesive tape to create the sample well.

For the preparation of immunosensors, anti-CXCL9 capture antibody (cAb) was first thiolated by incubating 1.1 μL of cAb at 100 μg mL⁻¹ with 2 μL of Traut's Reagent in 97 μL of 2 mM EDTA for 1 hour at room temperature with agitation (525 rpm) using an orbital shaker. 300 μL of PBS was added to the solution and centrifuged at 12,000 g for 10 min through a 10 kDa filter (Micron, Somerset, NJ) to remove excess reagent. The dispersed phase was removed and 50 μL of PBS was centrifuged through the filter in the reverse direction at 12,000 g for 1min to release the captured cAb. Thiolated cAb was immobilized on the SPGE sensor by incubating 8 μL of cAb solution on the working electrode (WE) for 2.5 hr at room temperature, followed by rinsing with 0.05% Tween 20 in PBS and gently drying with purified N₂.

StabilBlock stabilizer solution was dispensed on the sensing electrodes and dried at room temperature to passivate the surface and increase the stability of the immobilized cAb. Prepared immunosensors were stored at 4° C. in a desiccator and used within one week.

In this embodiment, antibody-coated AuNPs were prepared by combining 80 μL of 30 nm AuNP solution (OD 1) with 5 μL of 0.2 mg mL⁻¹ biotinylated anti-CXCL9 detection antibody (dAb), incubated for 30 min with agitation (300 rpm) and allowed to rest for 40 min. 3.2 mg of BSA was added to the solution, vortexed for 30 s, incubated for 30 min with agitation (300 rpm) and allowed to rest for 40 min. The solution was then centrifuged at 8,500 g for 10 min, the supernatant was removed and resuspended in 4.8 μL of Stabilblock with 0.25% Tween 20 diluted in 75.2 μL of 20% sucrose in Stabilblock. Prepared dAb-AuNPs were stored at 4° C. and used within two days.

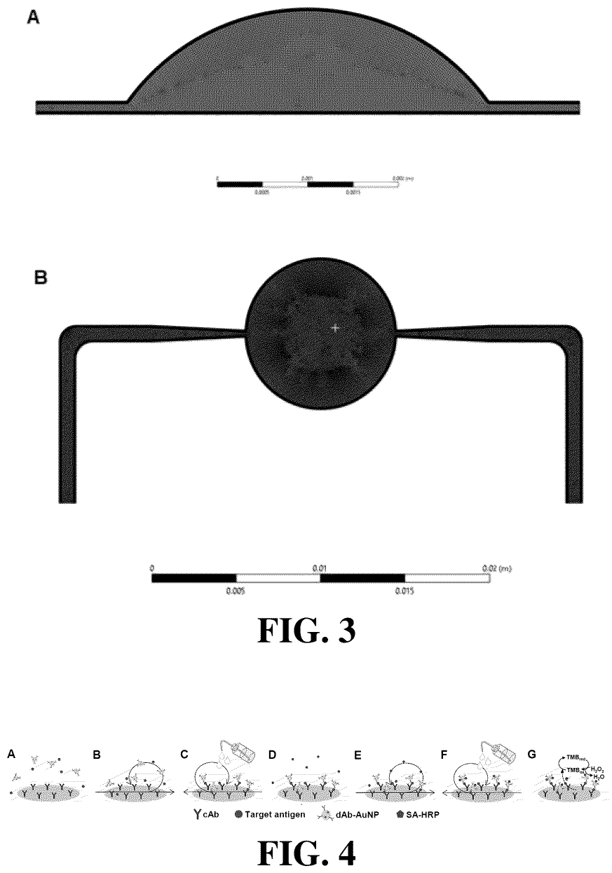

Velocity fields and streamlines of fluid flow were simulated in a transient numerical simulation using Ansys Fluent software (Canonsburg, PA). For these simulations, the model consisted of 1 mm-wide, enclosed rectangular channels connected to an 8 mm-diameter circular well (open to the atmosphere) filled with 100 μL of liquid. Fluid flow in the sample well resulting from the depression of the actuation chamber was simulated by applying an average velocity of 0.24 m s⁻¹ (determined experimentally) through the inlet of the sample well and a boundary condition of standard atmospheric pressure on the surface of the liquid droplet inside the well. As shown in FIG. 3, simulations were performed using non-uniform unstructured meshes with a mesh element size of 100 μm with an inflation element of 1.2 with 20 elements being used along wall elements for increased resolution at points of interaction.

For flow visualization, 10 μm red microbeads were used as tracer particles to visualize the flow patterns in a liquid droplet in the sample well (e.g. equivalent to sample well 130 shown in FIG. 1) upon actuation of the mixer. 100 μL of 1% BSA in 1×PBS was first dispensed into the sample well of a microfluidic immunosensor chip without the SPGE sensor. 2 μL of microbead solution was then dispensed in the droplet, followed by actuation of the mixer (e.g. depression of actuation chambers equivalent first and second actuation chambers 110 and 120, shown in FIG. 1). The motion of the microbeads was recorded using a digital microscope (VHX-7000, Keyence).

Electrochemical measurements were performed with 10 μL of cAb-AuNP solution first mixed with 100 μL of human plasma spiked with varying concentrations of CXCL9, vortexed for 5 s, and dispensed into the sample well of a microfluidic immunosensor chip. The actuation chambers were pressed in an alternating manner at a frequency of approximately 2 Hz to induce mixing within the droplet, followed by a period of static incubation without mixing. The sensing electrodes were rinsed by dispensing wash buffer (0.05% Tween 20 in 1×PBS) into the sample well and pressing the actuation chambers for ten cycles followed by gentle drying with N2. 100 μL of SA-HRP diluted at 1:200 in PBS was then dispensed into the sample well and mixed for 2.5 min, followed by static incubation for 2.5 min. The sensing electrodes (e.g.

equivalent to sensor 140 shown in FIG. 1) were rinsed using wash buffer and dried using N₂ as described above. 100 μL of TMB peroxidase substrate was dispensed into the sample well and incubated for 1 min. Chronoamperometric measurements were performed by applying a bias potential of −0.2 V (vs. Ag/AgCl) for 120 s using a PalmSens4 potentiostat (PalmSens, Netherlands) or a smartphone-based diagnostic device consisting of a Sensit Smart potentiostat connected to a Google Pixel 6™ smartphone. This bias potential was optimized in the inventors' prior studies using the same SPGE sensor, HRP and TMB peroxidase substrate [17,29,30]. Amperometric currents were obtained at 120 s of chronoamperograms.

Electrochemical measurements without mixing were performed by dispensing 100 μL of spiked plasma into the sample well and incubating for 1 hr, followed by rinsing and drying. Next, 100 μof dAb-AuNP solution was dispensed into the sample well, incubated for 1 hr, followed by rinsing and drying. 100 μL of SA-HRP diluted at 1:200 in PBS was then dispensed into the sample well, incubated for 20 min, followed by rinsing and drying. All incubations were performed at room temperature. Rinsing and drying of the sensing electrodes, and chronoamperometric measurements were performed as described above.

As shown in FIG. 1, panel B, the microfluidic chip comprises a finger-actuated mixer integrated with an SPGE sensor. The mixer is comprised of an 8 mm-diameter sample well, which encloses the sensing electrodes in fluid communication with two 10 mm-diameter compressible actuation chambers via 1 mm-wide channels. The width of the channels gradually reduces to 0.45 mm where they connect to the sample well, forming a nozzle. Liquid samples are dispensed in the sample well and form a droplet on the sensing electrodes due to the liquid being pinned by the circular ring.

As shown in FIG. 1, panel C, to initiate mixing, the actuation chambers are pressed (using one's fingers) in an alternating manner, causing liquid to flow back-and-forth through the nozzles and the sample well. The depression of the actuation chamber results in pressure differential of approximately 1.4 kPa across the channel (Reynolds number, Re=approximately 60), which was calculated as described by Fuerstman et al. [31]. The volume flow rate was determined experimentally by measuring the fluid velocity upon depression of the actuation chamber. This pressure differential causes the liquid in the channel to accelerate through the nozzle (Re=approximately 100), forming a microfluidic jet upon entering the sample well. The transition from the narrow nozzle exit to the larger diameter well causes the jet to quickly decelerate as it encounters the bulk fluid, resulting in the leading portion of the jet to roll into toroidal-shaped microvortices32. These microvortices generate mixing in the liquid droplet, which enhances antibody-antigen reactions and promotes immunocomplex formation. Furthermore, the trajectory of the microflows directs dAb-AuNPs and target analytes toward the cAb-immobilized WE, thus promoting antigen-antibody binding, resulting in an amplified detection signal.

The exemplary embodiments of the present disclosure utilized for this testing employed dAb-labeled AuNPs, which provides more binding sites for the target protein and enhances electron transfer during electrochemical reactions, leading to an amplified detection signal [33, 34]. To initiate a measurement, dAb-AuNPs are added to the sample, which is then dispensed into the sample well and incubated for 15 min, as shown in FIG. 4, panel A). If the sample contains the target protein (CXCL9), it binds to the dAb-AuNP and forms a CXCL9-dAb-AuNP immunocomplex, which subsequently binds to the cAb-immobilized WE. SA-HRP is then dispensed into the sample well and incubated for 5 min, as shown in FIG. 4, panel D), which binds to the immobilized CXCL9-dAb-AuNP immunocomplexes. Mixing is performed during the incubation of the dAb-AuNPs and SA-HRP, which promotes immunocomplex formation and accelerates the transport of CXCL9-dAb-AuNP immunocomplexes/SA-HRP molecules to the sensor surface as shown in FIG. 4, panels B and E, followed by washing shown in FIG. 4 panels C and F. In this embodiment, a TMB peroxidase substrate is dispensed into the sample well and the HRP-labeled AuNPs catalyze the reduction of H₂O₂ and the oxidation of TMB. Upon the application of a bias potential between the working and reference electrodes, the product of this enzymatic reaction (TMBₒₓ) is reduced on the WE35, resulting in the generation of an amperometric current that is proportional to the concentration of CXCL9 attached to the WE (FIG. 4G). If the sample does not contain CXCL9, then the dAb-AuNPs are washed away from the sensor surface and a negligible amperometric signal is generated upon the application of a bias potential.

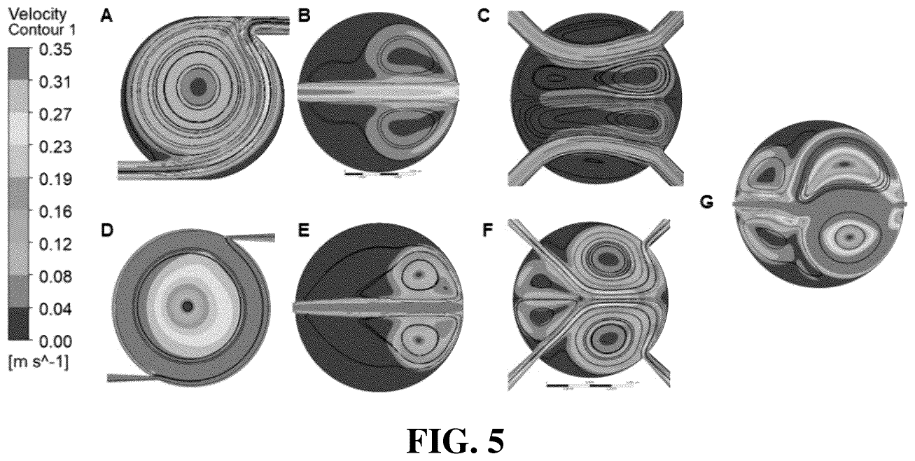

Numerical simulations were performed to optimize the design of the mixer and study the flow characteristics (e.g., velocity field, streamlines) in the sample well upon actuation of the mixer. The inventors first simulated flows using different mixer designs, including two different radial designs, where the inlet(s) and outlet(s) were oriented toward the center of the sample well, and a tangential design, where the inlet and outlet were arranged in a tangential orientation with respect to the sample well, having constant-width channels. The tangential design resulted in circulating flows around the perimeter of the well with concentric streamlines with a significantly slower flow velocity at the center of the well as shown in FIG. 5, panel A. The radial mixer designs resulted in the generation of microvortices within the droplet that directed flow toward the WE. More pronounced microvortices were generated for the mixer with a single inlet and outlet (shown in FIG. 5, panel B) than the mixer with two inlets and outlets (shown in FIG. 5, panel C), which can be attributed to a faster microfluidic jet velocity through the nozzle [32]. These simulation results revealed that the radial mixer design with a single inlet and outlet was most effective in generating mixing within the droplet in the well and directing the fluid toward the WE.

Simulations were then performed to optimize the geometry of the nozzle. For these simulations, nozzles with different contraction ratios (i.e., the ratio of the width at nozzle inlet to the width at the nozzle exit) were investigated. Compared with mixers having constant-width inlet and outlet channels (contraction ratio=1) (shown in FIG. 5, panels A-C), more pronounced microvortices with faster flow velocities were generated for mixers with nozzles (shown in FIG. 5, panels D-G). The radial mixer with a nozzle contraction ratio of 2 was selected as the optimal design since this mixer resulted in symmetric vortices that were centered over the WE, as shown in FIG. 5, panel E.

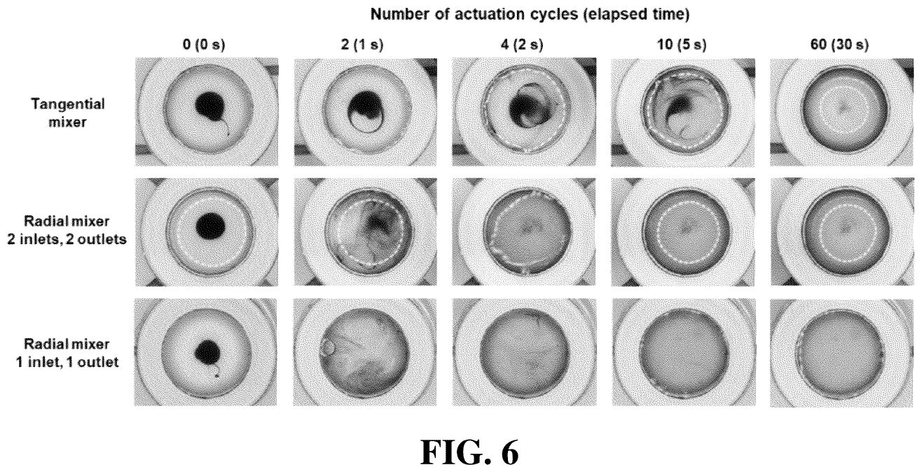

Experiments were conducted to characterize the mixing efficacy for each mixer design. For these experiments, red polystyrene beads were dispensed in the middle of a PBS droplet in the sample well of microfluidic chips (without the SPGE sensor) having different mixer designs, and videos of the droplet were recorded upon actuation of the mixer. The inventors observed that the radial mixer with a single inlet and outlet generated a superior mixture homogeneity in the shortest amount of time (10 s) compared with the other mixer designs, as shown in FIG. 6. These experimental results are consistent with the numerical simulation results which show that the radial mixer design with a single inlet and outlet generated pronounced symmetric microvortices with the fastest flow velocity compared with the other mixer designs, as shown in FIG. 5.

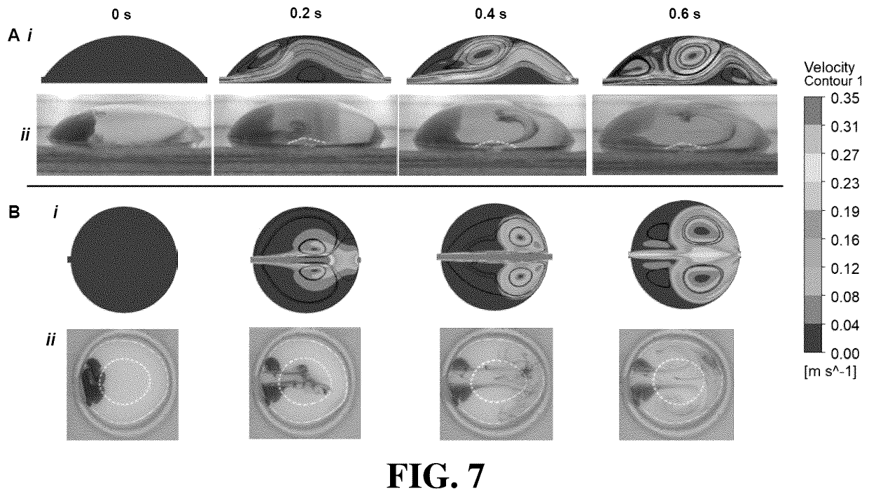

Using the optimized mixer design, simulations were performed to characterize the formation of the microvortices within a droplet in the sample well upon actuation of the mixer. Simulation results of flow inside the droplet at varying time points are shown in FIG. 7, panel A, i (side view) and FIG. 7, panel B, I (top view). The streamlines indicate that the microvortices facilitate mixing within the droplet while directing the flow (as well as the dAb-AuNPs and proteins suspended in the liquid) from the bulk solution toward the WE. Experiments were performed to visualize the microflows generated in the sample well filled with 1×PBS by dispensing red microbeads (used as tracer particles) in the well prior to actuating the mixer.

Upon depression of the actuation chamber, microvortices are formed in the droplet within 0.2 s (FIG. 7, panel A, ii (side view), FIG. 7 panel B, ii (top view)). The motion of the beads is consistent with the streamlines predicted by the numerical simulations (FIG. 7 panel A, i (side view), FIG. 7 panel B, i (top view)), validating the accuracy of our model. The swirling microflows lead to mixing within the liquid, which enhances antibody-antigen reactions and promotes antigen-antibody immunocomplex formation. These experimental results further demonstrates that microparticles can be transported across relatively large distances within the sample well, verifying the effectiveness of the finger-actuated mixer in transporting smaller particles, such as dAb-AuNPs and proteins, within the droplet.

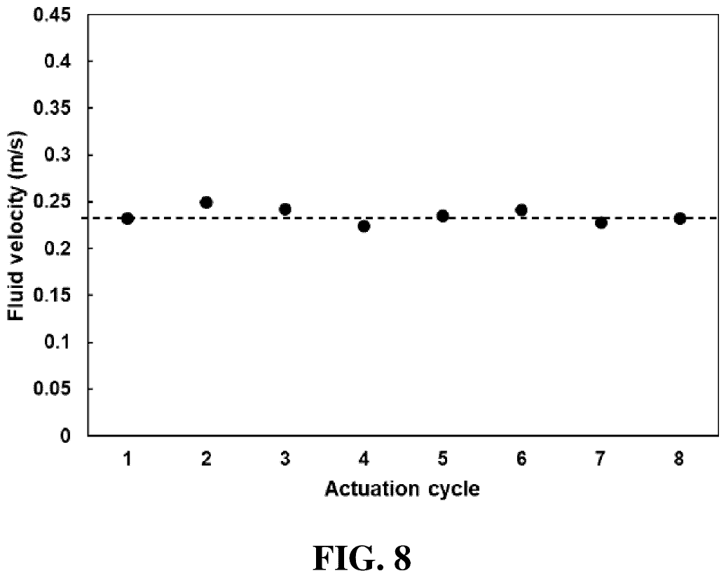

The reproducibility of the finger-actuated mixer was briefly studied by measuring the fluid velocity in the channel generated by pressing the actuation chambers for multiple cycles. The fluid velocity was consistent (<6% deviation from the mean velocity) across multiple actuation cycles, as shown in FIG. 8, indicating that the finger-actuated mixer can be operated with high reproducibility.

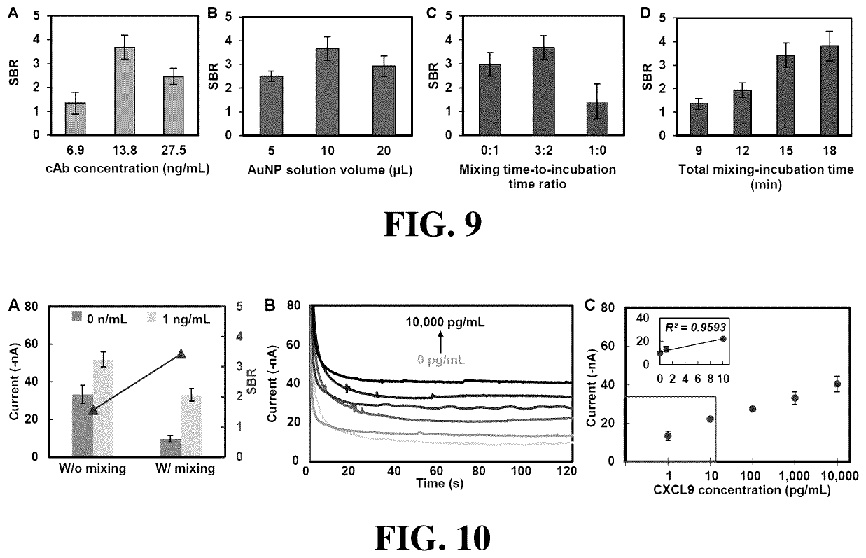

Several assay parameters, including the cAb concentration, the amount of dAb-AuNPs, the ratio of the mixing time to the static incubation time and the total mixing and incubation time, were optimized to enhance the analytical performance of the immunosensor. For each parameter that was optimized, the inventors evaluated the signal-to-background ratio (SBR) based on the amperometric signals generated from samples spiked with CXCL9 at 0 ng mL⁻¹ or 10 ng mL⁻¹ . The cAb concentration was optimized by performing measurements using sensing electrodes that were prepared with solutions having varying cAb concentrations. The solution with a cAb concentration of 13.8 ng mL⁻¹ produced the largest SBRs and was selected as the optimal concentration, as shown in FIG. 9, panel A. The optimal amount of dAb-AuNPs was determined by performing measurements using varying volumes of dAb-AuNP solution. A dAb-AuNP solution volume of 10 μL resulted in ˜1.5-fold increase in the SBR compared with the use of a smaller (5 μL) volume of dAb-AuNP solution, as shown in FIG. 9, panel B. Using dAb-AuNP solution volumes>10 μL resulted in a decrease in the SBR, which the inventors attribute to the presence of additional AuNPs, which can nonspecifically bind to the sensor surface and lead to a higher background signal. The ratio of the mixing time to the static incubation time was optimized by performing measurements using varying mixing time-to-static incubation time ratios. SBRs obtained with a 3:2 mixing-to-static incubation time ratio were ˜2.5-fold larger than those obtained without mixing (i.e., 0:1 ratio) as shown in FIG. 9, panel C. The use of a mixing-to-static incubation time ratio of 1:0 resulted in a decrease in the SBR, which the inventors attribute to the detachment of dAb-AuNP conjugates from the sensor surface as a result of prolonged mixing. Therefore, 3:2 was selected as the optimal mixing time-to-static incubation time ratio. The last parameter that was optimized was the total mixing and static incubation time. The inventors observed a positive correlation between the total mixing-incubation time and the SBR where longer times resulted in higher SBRs, as shown in FIG. 9, panel D. There was a negligible improvement in the SBR by increasing the total mixing-incubation time from 15 to 18 min, thus, 15 min was selected as the optimal total mixing-incubation time.

The inventors first evaluated the influence of performing mixing during the incubation steps on the analytical performance of this immunosensor. Measurements of plasma samples spiked with CXCL9 at 0 ng mL⁻¹ or 1 ng mL⁻¹ were performed using the smartphone-based diagnostic device with mixing-enhanced incubations or static incubations only (without mixing). SBRs obtained with mixing were approximately 2-fold higher than those obtained with static incubations only as shown FIG. 10, panel A. This result demonstrates the effectiveness of the finger-actuated mixer in enhancing the analytical performance of the immunosensor while shortening the detection time from 140 min to less than 25 min. Next, the inventors evaluated the analytical sensitivity (i.e., lower limit of detection [LOD]) of this immunosensor by performing measurements of plasma samples with increasing concentrations of CXCL9. Chronoamperograms generated from the samples showed a positive correlation between the amperometric current and the CXCL9 concentration as shown in FIG. 10, panel B. A calibration curve for the immunosensor was generating by plotting the amperometric current at 120 s of chronoamperograms vs. the CXCL9 concentration, which revealed a linear response from 0 to 10 pg mL⁻¹ with a R² correlation coefficient of 0.959 as shown in FIG. 10, panel C. The lower LOD of this immunosensor, calculated as 3× the SD divided by the slope of the linear calibration curve36, is 4.7 pg mL⁻¹, which is at least 20× more sensitive than a colorimetric HRP-based CXCL9 ELISA [37]. The detection range of this immunosensor encompasses the CXCL9 levels in the serum of individuals with autoimmune and inflammatory diseases, such as juvenile idiopathic arthritis (4,576-60,961 pg mL⁻¹)[23], rheumatoid arthritis (1,245-4,899 pg mL⁻¹) and eosinophilic asthma (˜40->1,000 pg mL⁻¹) [25], demonstrating the broad utility of this device for point-of-care diagnostic testing.

Exemplary embodiments of the present disclosure provide a microfluidic electrochemical immunosensor that employs a unique finger-actuated mixer for rapid, ultrasensitive measurements of protein biomarkers in human plasma. Through numerical simulations, flow visualization and electrochemical measurements, it is shown that microvortices generated via actuation of the mixer accelerates biomolecular transport, enhances antibody-antigen interactions and promotes immunocomplex formation, all of which leads to improved immunosensor performance. The analytical sensitivity of this immunosensor was evaluated by performing measurements of human plasma samples spiked with CXCL9, which could be detected at concentrations as low as 4.7 pg mL⁻¹ within 25 min. Measurements were performed using a handheld smartphone-based diagnostic device, which does not require external pumps, sophisticated equipment or grid electricity, making this platform suitable for point-of-care testing in resource-limited settings. Exemplary embodiments of the present disclosure may be readily adapted to detect other clinically relevant biomarkers by replacing the capture and detection antibodies with different bioreceptors, thereby expanding its utility for diagnostic testing.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
1. G. L. Hortin, S. A. Carr and N. L. Anderson, Clin Chem, 2010, 56, 149-151.
2. S. Zhang, A. Garcia-D'Angeli, J. P. Brennan and Q. Huo, Analyst, 2013, 139, 439-445.
3. G. Gauglitz, Annual Review of Analytical Chemistry, 2014, 7, 297-315.
4. V. Gubala, L. F. Harris, A. J. Ricco, M. X. Tan and D. E. Williams, Anal Chem, 2012, 84, 487-515.
5. J. F. Rusling, C. V. Kumar, J. S. Gutkind and V. Patel, Analyst, 2010, 135, 2496-2511.
6. S. Choi, M. Goryll, L. Y. M. Sin, P. K. Wong and J. Chae, Microfluid Nanofluidics, 2011, 10, 231-247.
7. Y. Wang, H. Xu, J. Zhang and G. Li, Sensors, 2008, 8, 2043-2081.
8. H. Karimi-Maleh, F. Karimi, M. Alizadeh and A. L. Sanati, Chemical Record, 2020, 20, 682-692.
9. C. Zhu, G. Yang, H. Li, D. Du and Y. Lin, Anal Chem, 2015, 87, 230-249.
10. A. K. Yetisen, M. S. Akram and C. R. Lowe, Lab Chip, 2013, 13, 2210-2251.
11. H. Becker and L. E. Locascio, Talanta, 2002, 56, 267-287.
12. A. Nilghaz, D. R. Ballerini and W. Shen, Biomicrofluidics, DOI:10.1063/1.4820413.
13. E. C. Wilkirson, K. L. Singampalli, J. Li, D. D. Dixit, X. Jiang, D. H. Gonzalez and P. B. Lillehoj, Anal Bioanal Chem, 2023, 415, 3983-4002.
14. M. Vestergaard, K. Kerman and E. Tamiya, Sensors, 2007, 7, 3442-3458.
15. O. Hofmann, G. Voirin, P. Niedermann and A. Manz, Anal Chem, 2002, 74, 5243-5250.
16. I. Pereiro, A. Fomitcheva Khartchenko, R. D. Lovchik and G. V. Kaigala, Angewandte Chemie—International Edition, 2021, 60, 20935-20942.
17. J. Li and P. B. Lillehoj, Angewandte Chemie—International Edition, DOI:10.1002/anie.202200206.
18. J. Park and J. K. Park, Anal Chem, 2019, 91, 11636-11642.
19. Y. Jo, J. Park and J. K. Park, Sensors (Switzerland),, DOI:10.3390/s20082267 .
20. N. Mishra, N. T. Garland, K. A. Hewett, M. Shamsi, M. D. Dickey and A. J. Bandodkar, ACS Sens, 2022, 7, 3169-3180.
21. W. Qi, L. Zheng, Y. Hou, H. Duan, L. Wang, S. Wang, Y. Liu, Y. Li, M. Liao and J. Lin, Food Chem, 2022, 381, 131801.
22. X. Liu, M. Li, J. Zheng, X. Zhang, J. Zeng, Y. Liao, J. Chen, J. Yang, X. Zheng and N. Hu, Micromachines (Basel),, DOI:10.3390/mi13091479.
23. M. Mizuta, M. Shimizu, N. Inoue, Y. Nakagishi and A. Yachie, Cytokine, 2019, 119, 182-187.
24. J. C. O'Brien, Y. B. Rainwater, N. Malviya, N. Cyrus, L. Auer-Hackenberg, L. S. Hynan, G. A. Hosler and H. T. Jacobe, Journal of Investigative Dermatology, 2017, 137, 1663-1670.
25. T. Hasegawa, T. Okazawa, H. Uga, H. Kurata and A. Mori, Allergy: European Journal of Allergy and Clinical Immunology, 2019, 74, 2515-2518.
26. W. P. Kuan, L. S. Tam, C. K. Wong, F. W. S. Ko, T. Li, T. Zhu and E. K. Li, Journal of Rheumatology, 2010, 37, 257-264.
27. C. T. Yuan, W. T. Huang, C. L. Hsu, H. Wang, Y. H. Pan, U. I. Wu, J. T. Wang, W. H. Sheng, Y. C. Chen and S. C. Chang, J Clin Immunol,, DOI:10.1007/s10875-023-01643- Z.
28. M. Usami, M. Shimizu, M. Mizuta, N. Inoue, H. Irabu, N. Sakumura, Y. Nakagishi and A. Yachie, Clinical Immunology, 2019, 208, 108255.
29. J. Li and P. B. Lillehoj, ACS Sens, 2021, 6, 1270-1278.
30. J. Li, A. M. Saidi, K. Seydel and P. B. Lillehoj, Biosens Bioelectron, 2024, 250, 116091.
31. M. J. Fuerstman, A. Lai, M. E. Thurlow, S. S. Shevkoplyas, H. A. Stone and G. M. Whitesides, Lab Chip, 2007, 7, 1479-1489.
32. J. O. Dabiri and M. Gharib, Proceedings of the Royal Society B: Biological Sciences, 2005, 272, 1557-1560.
33. J. Lei and H. Ju, Chem Soc Rev, 2012, 41, 2122-2134.
34. X. Cao, Y. Ye and S. Liu, Anal Biochem, 2011, 417, 1-16.
35. P. Fanjul-Bolado, M. González-García and A. Costa-García, Anal Bioanal Chem, 2005, 382, 297-302.
36. D. C. Harris, Quantitative Chemical Analysis. W.H. Freeman and Co., New York.
37. I. Lee. S. J. Kwon. M. Sorci. P. S. Heeger and J. S. Dordick. Anal Chem, 2021, 93, 16528-16534.

1. An apparatus for analyzing a sample, the apparatus comprising:
a sample well;
a first actuation chamber;
a first nozzle;
a second actuation chamber;
a second nozzle; and
a sensor, wherein:
the first actuation chamber is in fluid communication with the sample well via the first nozzle; and
the second actuation chamber is in fluid communication with sample well via the second nozzle.

2. The apparatus of claim 1 wherein the sample well is configured to allow a user to access the sample well.

3. The apparatus of claim 1 wherein the sample well comprises a removable seal.

4. The apparatus of claim 1 wherein the first nozzle and the second nozzle are directed towards a center region of the sample well.

5. The apparatus of claim 4 wherein the first nozzle and the second nozzle are oriented approximately 180 degrees apart.

6. The apparatus of claim 5 wherein the first nozzle and the second nozzle are directed towards each other.

7. The apparatus of claim 1 wherein at least one of the first nozzle or the second nozzle has a contraction ratio of approximately 1.5 to 2.5.

8. (canceled)

9. The apparatus of claim 1 wherein both the first nozzle and the second nozzle have a contraction ratio of approximately 2.0.

10. The apparatus of claim 1 wherein the apparatus does not comprise an additional nozzle in addition to the first nozzle and the second nozzle.

11. The apparatus of claim 1 wherein the sensor comprises a conductive planar electrode.

12. The apparatus of claim 1 wherein the first actuation chamber and the second actuation comprise a plastic film.

13. A method of analyzing a sample, the method comprising:
introducing the sample to a sample well;
depressing a first actuation chamber to direct fluid flow through a first nozzle into the sample well;
depressing a second actuation chamber to direct fluid flow through a second nozzle into the sample well; and
analyzing the sample via a sensor.

14. The method of claim 13 further comprising alternately repeating depressing the first actuation chamber and the second actuation chamber.

15. The method of claim 13 wherein:
the sample well comprises a removable seal; and
the method further comprises removing the removable seal prior to introducing the sample to a sample well

16. The method of claim 13 wherein;
the first nozzle and the second nozzle are directed towards a center region of the sample well;
the first nozzle and the second nozzle are oriented approximately 180 degrees apart; and
the first nozzle and the second nozzle are directed towards each other.

17-18. (canceled)

19. The method of claim 13 wherein at least one of the first nozzle or the second nozzle has a contraction ratio of approximately 1.5 to 2.5.

20. (canceled)

21. The method of claim 13 wherein both the first nozzle and the second nozzle have a contraction ratio of approximately 2.0.

22. The method of claim 13 wherein the apparatus does not comprise an additional nozzle in addition to the first nozzle and the second nozzle.

23. The method of claim 13 wherein the sensor comprises a conductive planar electrode.

24. The method of claim 13 wherein:
the first actuation chamber and the second actuation comprise a plastic film; and
depressing the first actuation chamber and the second actuation comprises depressing the plastic film.

25. (canceled)
